(19) United States
(12) Patent Application Publication
(10) Pub. No.: US 2025/0036147 A1
(43) Pub. Date: Jan. 30, 2025

(54) TRANSPORT METHOD

(71) Applicant: MITSUBISHI HEAVY INDUSTRIES, LTD., Tokyo (JP)

(72) Inventors: Makoto HIRAI, Tokyo (JP); Ichiro OBA, Tokyo (JP); Daisuke YAMAGUCHI, Tokyo (JP); Yohei TAKAYAMA, Tokyo (JP); Masashi YOSHIDA, Tokyo (JP)

(21) Appl. No.: 18/741,843

(22) Filed: Jun. 13, 2024

(30) Foreign Application Priority Data
Jul. 26, 2023 (JP) 2023-121367

(51) Int. Cl. G05D 1/695; G05D 1/248; G05D 105/20; G05D 109/20; G05D 111/10

(52) U.S. Cl. CPC G05D 1/695; G05D 1/248; G05D 2105/20; G05D 2109/20; G05D 2111/17

(57) ABSTRACT

In a method of transporting cargo suspended by multiple UAVs, each of the multiple UAVs flies such that a relative positional relationship of each of the multiple UAVs to the cargo is maintained. This method of transporting cargo is achieved by one or both of a ground position control mode in which flight of each of the multiple UAVs is controlled to follow a change in a position of the cargo relative to the ground, and an interval control mode in which the flight of each of the multiple UAVs is controlled so as to maintain an interval of each of the multiple UAVs to the cargo.

### CROSS-REFERENCE TO RELATED APPLICATIONS

This application claims the benefit of priority to Japanese Patent Application Number 2023-121367 filed on Jul. 26, 2023. The entire contents of the above-identified application are hereby incorporated by reference.

### TECHNICAL FIELD

The present disclosure relates to a method of transporting cargo using an unmanned aerial vehicle (UAV).

### RELATED ART

A UAV is capable of taking off and landing vertically, which allows the UAV to transport cargo even when only a small space is available. For example, JP 2022-63524 A discloses a towing system that uses multiple UAVs to tow an aircraft. More specifically, JP 2022-63524 A proposes that an aircraft with a fuselage and fixed wings be towed by multi-fans serving as UAVs with multiple electric fans. Therefore, J P 2022-63524 A can be regarded as a cargo transport system using multiple UAVs.

### SUMMARY

When transporting cargo using a UAV, it is necessary to select an unmanned aircraft capable of transporting the cargo depending on the weight and size of the cargo. That is, the maximum weight that can be transported is determined as follows. For a small-sized UAV, as an example, the maximum payload is several kilograms, and for a medium-sized UAV, as an example, the maximum payload is several hundred kilograms. In addition to the payload, there are also restrictions on dimensions of the cargo to be transported. That is, for cargo that is longer than an entire length of the UAV, it is not easy to align the center of gravity of the cargo with the center of gravity of the UAV, or to maintain posture of the cargo when the cargo is hit by a gust of wind or a crosswind.

Thus, an object of the present disclosure is to provide a method of transporting cargo that is not easy to transport by a single UAV, such as a heavy object or a long object, in a stable posture using multiple UAVs.

According to the present disclosure, in a method of transporting cargo suspended by multiple unmanned aerial vehicles, the multiple unmanned aerial vehicles each fly while controlling positions of the multiple unmanned aerial vehicles with reference to a position of the cargo.

According to the present disclosure, the multiple unmanned aerial vehicles each fly while controlling the positions of the multiple unmanned aerial vehicles with reference to the position of the cargo. Therefore, according to the present disclosure, it is possible to transport cargo that is not easy to transport by a single UAV, such as a heavy object or a long object, in a stable posture using multiple UAVs.

### BRIEF DESCRIPTION OF DRAWINGS

The disclosure will be described with reference to the accompanying drawings, wherein like numbers reference like elements.

FIG. 1 is a diagram illustrating an overview of a method of transporting cargo according to an embodiment.

FIG. 2 is a diagram for explaining maintenance of a relative positional relationship in a ground position control mode.

FIG. 3 is a diagram for explaining maintenance of a relative positional relationship in the ground position control mode.

FIG. 4 is a diagram illustrating configurations of a first controller (Lug.) provided in cargo and a second controller (UAV) provided in a UAV.

FIG. 5 is a diagram illustrating preferable thrust force according to the present embodiment.

FIG. 6 is a diagram for explaining maintenance of a relative positional relationship in an interval control mode.

FIG. 7 is a diagram illustrating an example of a transport formation.

FIG. 8 is a diagram illustrating another example of the transport formation.

FIG. 9 is a diagram for explaining another example of maintaining a relative positional relationship.

FIG. 10 is a diagram for explaining another example of maintaining a relative positional relationship.

### DESCRIPTION OF EMBODIMENTS

A transport method and a transport system according to an embodiment will be described with reference to the accompanying drawings.

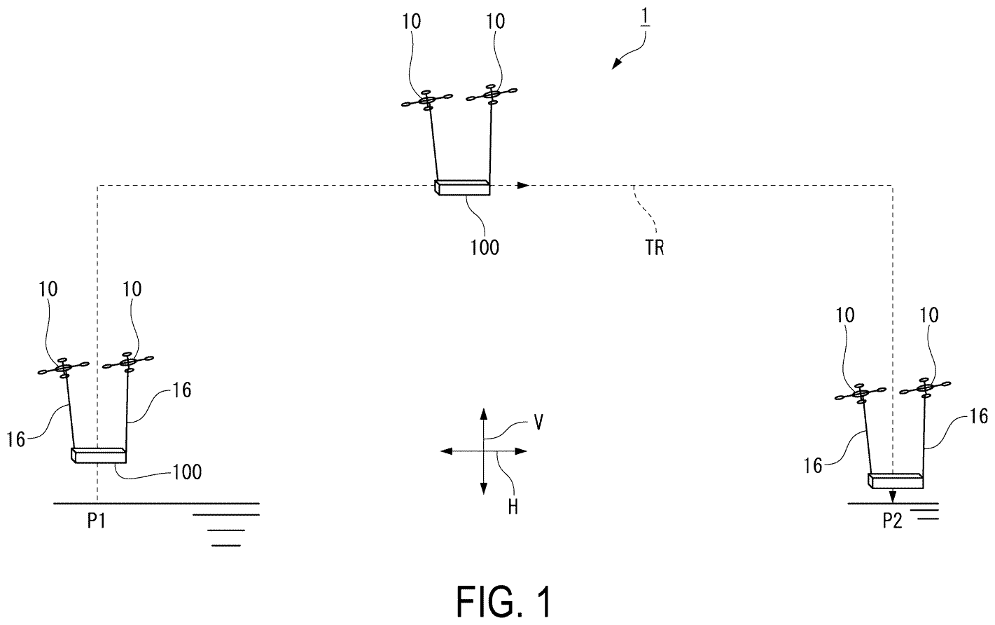

### Outline of Transport Method: See FIG. 1

In a method of transporting cargo according to the embodiment, as illustrated in FIG. 1, a cargo 100 is transported from a transport source P1 to a transport destination P2 via a transport route TR. Note that the transport route TR in FIG. 1 is illustrated for convenience of explanation, and the cargo 100 may be transported while deviating from the planned transport route TR by an allowable range. In the present embodiment, a horizontal direction H and a vertical direction V are defined, as illustrated in FIG. 1.

As an example, the cargo 100 departs from the transport source P1 suspended from multiple UAVs 10 via suspension cables 16. The multiple UAVs can transport the cargo 100 that is not easily transported by a single UAV 10, such as a heavy object or a long object, to the transport destination P2 in a stable posture. Therefore, collisions between the cargo 100 and the multiple UAVs 10 that suspend and transport the cargo 100, and collisions between the multiple UAVs 10 can be avoided along the transport route TR.

Note that the term “UAV” in the present disclosure refers to an aircraft that is structurally incapable of carrying humans but is capable of autonomous flight, and is synonymous with a drone.

Further, the cargo 100 in the present disclosure is not limited to a specific type of cargo. The cargo 100 can be not only a solid, which itself may be the object to be transported, but also a gas or a liquid when stored in a container.

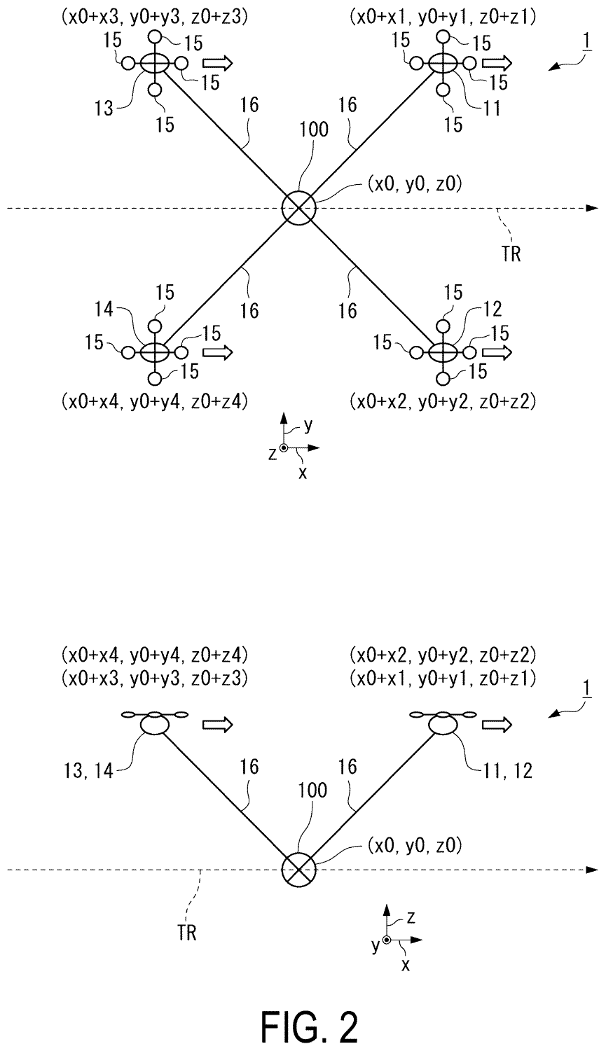

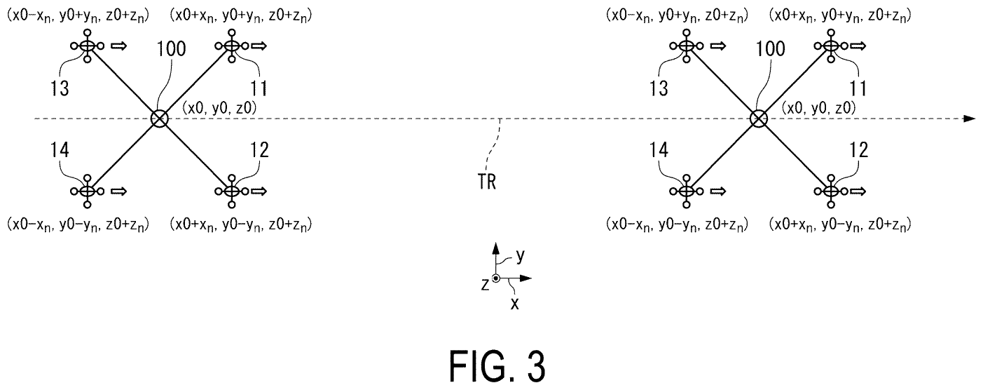

### Ground Position Control Mode: See FIGS. 2 and 3

Next, a specific example of a method of transporting the cargo 100 in a transport system 1 will be described. What will be described here is a transport method using a ground position control mode according to the present disclosure.

In a specific example of the transport method, four UAVs 11, 12, 13, and 14 transport the cargo 100 from the transport source P1 to the transport destination P2 following the transport route TR. The cargo 100 is transported suspended from the four UAVs 11, 12, 13, and 14 via the suspension cables 16.

In the transport method according to the present disclosure, current positions of the cargo 100 and the four UAVs 11, 12, 13, and 14 relative to the ground are defined as follows. Information about these positions can be continuously acquired using a global positioning system (GPS) as an example of a global navigation satellite system (GNSS). In addition to a GPS, satellites used in a global navigation satellite system include QZSS (Japan), GLONASS (Russia), and Galileo (EU), and any one of them can be used.
Cargo 100: (x100, y100, z100)
UAV 11: (x11, y11, z11)
UAV 12: (x12, y12, z12)
UAV 13: (x13, y13, z13)
UAV 14: (x14, y14, z14)

In the present embodiment, flight of the four UAVs 11, 12, 13, and 14 is controlled such that relative positions of the four UAVs 11, 12, 13, and 14 to the cargo 100 are maintained. Therefore, the position of the cargo 100 is defined as a cargo location information LI, as follows, and the positions of the four UAVs 11, 12, 13, and 14 are defined as follows using the cargo location information LI. These pieces of information are referred to as a UAV location information UI.

Cargo location information (current location information) LI
Cargo 100: (x0, y0, z0)

UAV location information UI
UAV 11: (x0+x1, y0+y1, z0+z1)
UAV 12: (x0+x2, y0+y2, z0+z2)
UAV 13: (x0+x3, y0+y3, z0+z3)
UAV 14: (x0+x4, y0+y4, z0+z4)

In the present embodiment, the flight of the four UAVs 11, 12, 13, and 14 is controlled such that the relative positions of the four UAVs 11, 12, 13, and 14 to the cargo 100 are constant. Assuming that parameters that specify this constant are xn, yn, and zn, the relative positions of the four UAVs 11, 12, 13, and 14 to the cargo 100 can be made constant when it is ensured that the four UAVs 11 12, 13, and 14 are at the following reference positions.

UAV reference location information URI
UAV 11: (x0+xn, y0+yn, z0+zn)
UAV 12: (x0+xn, y0−yn, z0+zn)
UAV 13: (x0−xn, y0+yn, z0+zn)
UAV 14: (x0−xn, y0−yn, z0+zn)

To ensure this, the UAV location information UI is compared with the UAV reference location information URI, and the operation of drive sources of each of the four UAVs 11, 12, 13, and 14 is controlled in a range where a difference Δ does not occur. That is, the four UAVs 11, 12, 13, and 14 fly so that Formula (1) is satisfied.

$$UAV reference location information URI = UAV location information UI \qquad Formula ( 1 )$$

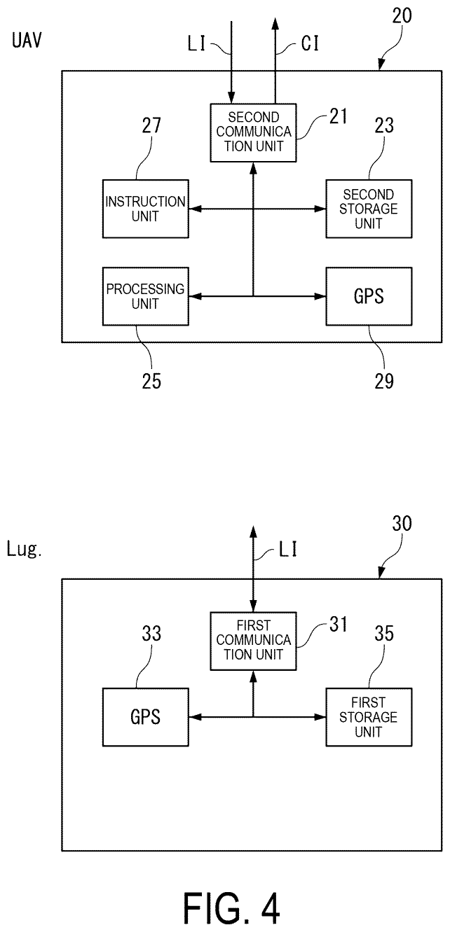

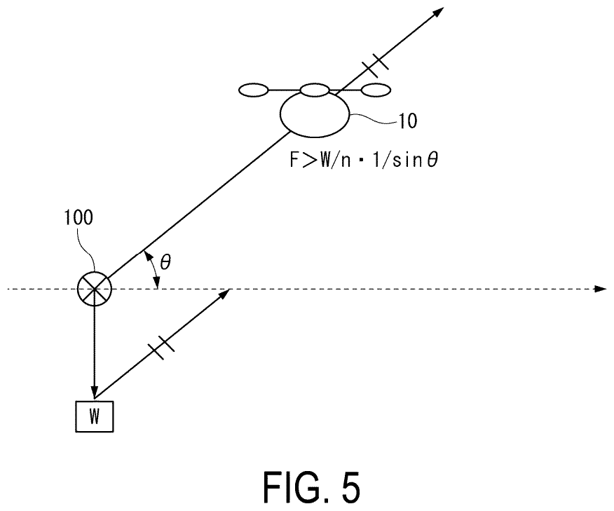

### Configuration of Transport System 1: See FIGS. 4 and 5

To achieve the above transport method, the transport system 1 includes a flight controller 20 provided in each of the four UAVs 11, 12, 13, and 14 and a location information generator 30 that is provided in the cargo 100 to generate the cargo location information LI. The flight controller 20 defines the flight of each of the four UAVs 11, 12, 13, and 14 based on the cargo location information LI acquired from the location information generator 30.

### Location Information Generator 30 Provided in Cargo 100: See FIG. 4

As an example, the cargo location information LI about the cargo 100 is generated using the global positioning system (GPS). The location information generator 30 includes a first communication unit 31 that receives electromagnetic waves from GPS satellites and transmits the calculated cargo location information LI, a GPS receiver 33 that calculates the cargo location information LI based on the electromagnetic waves received from the GPS satellites, and a first storage unit 35 that stores the calculated cargo location information LI.

Since GPS is well known, a detailed description of GPS will be omitted here. GPS includes three elements: GPS satellites (space segment), a ground control (control segment) that maintains the GPS satellites as necessary, and a GPS receiver (user segment) that receives electromagnetic waves from the GPS satellites and calculates the position. The location information generator 30 includes the GPS receiver and generates the cargo location information LI that specifies the position of the cargo 100. The cargo location information LI includes three elements: latitude (x), longitude (y), and altitude (z). The location information generator 30 calculates the cargo location information LI over time by continuously receiving electromagnetic waves from the GPS satellites.

The cargo location information LI obtained by the GPS receiver 33 is transmitted from the first communication unit 31 to the four UAVs 11, 12, 13, and 14. Note that the cargo location information LI can also be transmitted from the cargo 100 to the four UAVs 11, 12, 13, and 14 via a relay station provided on the ground, for example. When the relay station receives the cargo location information LI, the relay station may generate a command information CI based on the cargo location information LI and transmit the command information CI to the four UAVs 11, 12, 13, and 14. Note that the relay station is not limited to being on the ground, and may be located on a ceiling of an aircraft, a satellite, or the like.

### UAVs 11, 12, 13, and 14: See FIGS. 2, 3, and 4

The UAVs 11, 12, 13, and 14 receive the cargo location information LI transmitted from the location information generator 30 in the cargo 100 and fly based on the command information CI generated based on the received cargo location information LI. Note that the UAVs 11, 12, 13, and 14 can fly by comparing predetermined flight route information with the cargo location information LI calculated by the GPS receiver 33 provided in the cargo 100.

As an example, the UAVs 11, 12, 13, and 14 support the suspension cables 16 for towing the cargo 100. Each of the UAVs 11, 12, 13, and 14 holds the suspension cable 16 and a total of four cables is connected to the cargo 100. Here, an example is illustrated in which the four UAVs 11, 12, 13, and 14 transport the cargo 100, but the number of UAVs is freely determined depending on weight and dimensions of the cargo 100.

The configuration of the UAVs 11, 12, 13, and 14 is not limited as long as the UAVs can fly autonomously based on the generated command information CI. Typically, a UAV 10 that includes rotary blades 15 at multiple locations is used. More specifically, a tricopter with three rotary blades, a quadcopter with four rotary blades, a hexacopter with six rotary blades, or the like may be applied. For example, the greater the number of the rotary blades 15, the greater the stability during flight, but this also increases the weight of the UAV 10 and increases the number of maintenance points. The UAV 10 to be used may be selected in consideration of these factors and the weight of the cargo 100 to be collected and transported.

Each of the UAVs 11, 12, 13, and 14 is provided with the controller 20 for generating the command information CI based on the transmitted cargo location information LI. As illustrated in FIG. 4, the controller 20 includes a communication unit 21, a storage unit 23, a processing unit 25, and an instruction unit 27. The controller 20 is composed of computer devices, and includes a central processing unit (CPU), a random access memory (RAM), a read only memory (ROM), and a computer-readable storage medium. A series of processing operations for enabling various functions is stored in the storage unit 23 in the form of a program, as an example, and the CPU reads the program into the RAM or the like and executes information processing and arithmetic processing to enable the various functions.

Note that the program may be pre-installed in the ROM or other storage medium, may be provided as being stored in the computer-readable storage medium, or may be distributed via a wired or wireless communication means.

The computer-readable storage medium includes a magnetic disk, a magneto-optical disk, a CD-ROM, a DVD-ROM, and a semiconductor memory.

The controller 20 may also include a GPS receiver 29. The GPS receiver 29 has the same function as the GPS receiver 33.

The communication unit 21 receives the cargo location information LI transmitted from the location information generator 30 in the cargo 100, and the received cargo location information LI is transferred to and stored in the storage unit 23. The processing unit 25 reads the cargo location information LI stored in the storage unit 23 and generates the command information CI. The storage unit 23 stores information such as a state estimation filter necessary for generating the command information CI from the cargo location information LI, and the processing unit 25 reads the state estimation filter and the like from the storage unit 23 and generates the command information CI. The generated command information CI is sent to the instruction unit 27, and the instruction unit 27 instructs the drive source of the UAV 10 to operate based on the command information CI.

To generate the command information CI, the cargo location information LI, which is the cargo location information LI in the cargo 100, is provided. Latitude, longitude, and altitude correspond to the cargo location information LI. By processing the cargo location information LI, the command information CI is obtained.

The command information CI is sent to the instruction unit 27, and the instruction unit 27 drives, for example, an electric motor, which is a drive source of the rotary blades 15, based on the command information CI to transport the cargo 100 to the transport destination P2.

### Advantageous Effects of Transport System 1

According to the transport system and the transport method executed by the transport system according to the embodiment, the following effects are achieved.

The multiple UAVs 11, 12, 13, and 14 are used when transporting the cargo 100 that is difficult to balance, such as a heavy object or a long object. Moreover, in the process of transport from the transport source P1 to the transport destination P2, by arranging and flying the UAVs 11, 12, 13, and 14 so as to maintain the relative positions of the UAVs 11, 12, 13, and 14 to the cargo 100 constant, the cargo 100 can be transported while always maintaining the same stable formation without collisions between UAVs and between the UAVs and the cargo 100.

With this method, it is possible to transport cargo such as a heavy object or a long object by increasing the number of UAVs 10 without being limited by the payload of a single UAV 10.

### Thrust Force of UAV 10: See FIG. 5

Thrust force per UAV 10 when transporting the cargo 100 with the multiple UAVs 10 is considered.

It is assumed that the number of UAVs 10 is n, the weight of the cargo 100 is W kg, and each UAV 10 bears the weight equally. A weight of W/n kg is then allocated to each UAV 10. Assuming that an angle between a horizontal plane and the rope or the like connecting the cargo 100 and the UAV 10 is θ, a thrust force F of the UAV 10 required to tow the cargo 100 is as shown in Formula (2). However, by making the maximum thrust force of the UAV 10 larger than F, even when the load borne by each UAV 10 becomes uneven due to wind or the cargo 100 swinging, control can be performed by supplementing with surplus thrust force.

$$F ( kgf ) = w / n \times 1 / sin θ \qquad Formula ( 2 )$$

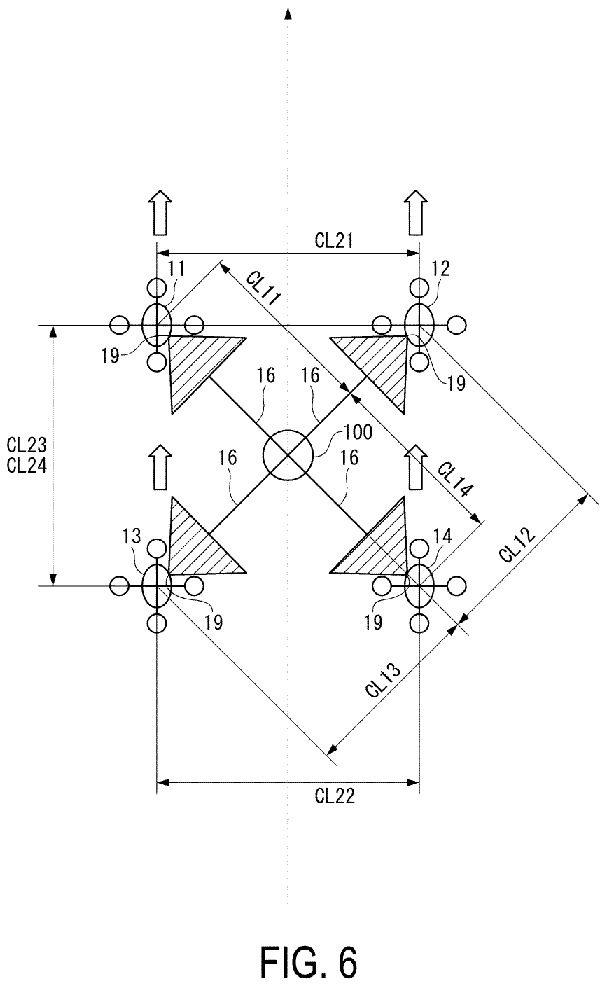

### Interval Control Mode: See FIG. 6

Although an example has been described in which the cargo location information LI is acquired by GPS to maintain the relative positions of the UAVs 11, 12, 13, and 14 to the cargo 100 constant, the present disclosure is not limited thereto.

The interval (distance) from each of the UAVs 11, 12, 13, and 14 to the cargo 100 and the interval (distance) between the UAVs 11, 12, 13, and 14 may be maintained. In this case, a first reference interval from each of the UAVs 11, 12, 13, and 14 to the cargo 100 and a second reference interval between the respective UAVs 11, 12, 13, and 14 are predetermined.

The first reference interval includes a distance CL11 between the UAV 11 and the cargo 100, a distance CL12 between the UAV 12 and the cargo 100, a distance CL13 between the UAV 13 and the cargo 100, and a distance CL14 between the UAV 14 and the cargo 100.

The second reference interval includes a distance CL21 between the UAV 11 and the UAV 12, a distance CL22 between the UAV 13 and the UAV 14, a distance CL23 between the UAV 11 and the UAV 13, and a distance CL24 between the UAV 12 and the UAV 14.

To measure the distances, each of the UAVs 11, 12, 13, and 14 is provided with a distance sensor 19. As an example, light detection and ranging (LiDAR) is applied to the distance sensor 19. LiDAR is a technology for measuring a distance to an object, a shape of the object, and the like based on information from the reflected light of a laser beam. The distance sensor 19 may be provided only in the cargo 100 to measure the distances between the cargo 100 and the UAVs 11, 12, 13, and 14, respectively.

The distance sensor 19 is used to measure a distance from the own UAV to the cargo 100 and an interval (distance) from the own UAV to another UAV. A first measured interval from the own UAV to the cargo 100 includes a first measured interval AL11 from the UAV 11 to the cargo 100, a first measured interval AL12 from the UAV 12 to the cargo 100, a first measured interval AL13 from the UAV 13 to the cargo 100, and a first measured interval AL14 from the UAV 14 to the cargo 100. A second measured interval from the own UAV to another UAV includes a second measured interval AL21 between the UAV 11 and the UAV 12, a second measured interval AL22 between the UAV 13 and the UAV 14, a second measured interval AL23 between the UAV 11 and the UAV 13, and a second measured interval AL24 between the UAV 12 and the UAV 14.

The first measured interval and the second measured interval are listed below.

### Reference Interval

First reference interval CLIN:
Distance CL11 between UAV 11 and cargo 100
Distance CL12 between UAV 12 and cargo 100
Distance CL13 between UAV 13 and cargo 100
Distance CL14 between UAV 14 and cargo 100

Second reference interval CL2N:
Distance CL21 between UAV 11 and UAV 12
Distance CL22 between UAV 13 and UAV 14
Distance CL23 between UAV 11 and UAV 13
Distance CL24 between UAV 12 and UAV 14

### Measured Interval

First measured interval AL1N:
Measured interval AL11 from UAV 11 to cargo 100
Measured interval AL12 from UAV 12 to cargo 100
Measured interval AL13 from UAV 13 to cargo 100
Measured interval AL14 from UAV 14 to cargo 100

Second measured interval AL2N:
Measured interval AL21 between UAV 11 and UAV 12
Measured Interval AL22 between UAV 13 and UAV 14
Measured Interval AL23 between UAV 11 and UAV 13
Measured Interval AL24 between UAV 12 and UAV 14

While the UAVs 11, 12, 13, and 14 are transporting the cargo 100, each of the UAVs 11, 12, 13, and 14 continuously measures the first measured interval ALIN and the second measured interval AL2N with the distance sensor 19. Each of the UAVs 11, 12, 13, and 14 compares the first measured interval ALIN with the first reference interval CLIN and also compares the second measured interval AL2N with the second reference interval CL2N. Then, the flight of the UAVs 11, 12, 13, and 14 is controlled so that the first measured interval ALIN coincides with the first reference interval CLIN and the second measured interval AL2N coincides with the second reference interval CL2N. That is, the UAVs 11, 12, 13, and 14 are controlled cooperatively with the cargo 100 at the center.

In addition to being measured by the distance sensor 19, the first measured interval ALIN and the second measured interval AL2N may be measured by comparing the location information acquired by the GPS receiver 29 provided in each of the UAVs 11, 12, 13, and 14 with the location information acquired by the GPS receiver 33 provided in the cargo 100.

### Effects of Interval Control Mode

The transport method by measurement of various distances and cooperative control can be used even when the distances from the UAVs 11, 12, 13, and 14 to the cargo 100 are short, and the distances between the UAVs 11, 12, 13, and 14 are short. That is, since the error in positioning by GPS is considered to be about several meters, the method by measurement of various distances and cooperative control is particularly effective when these distances are short.

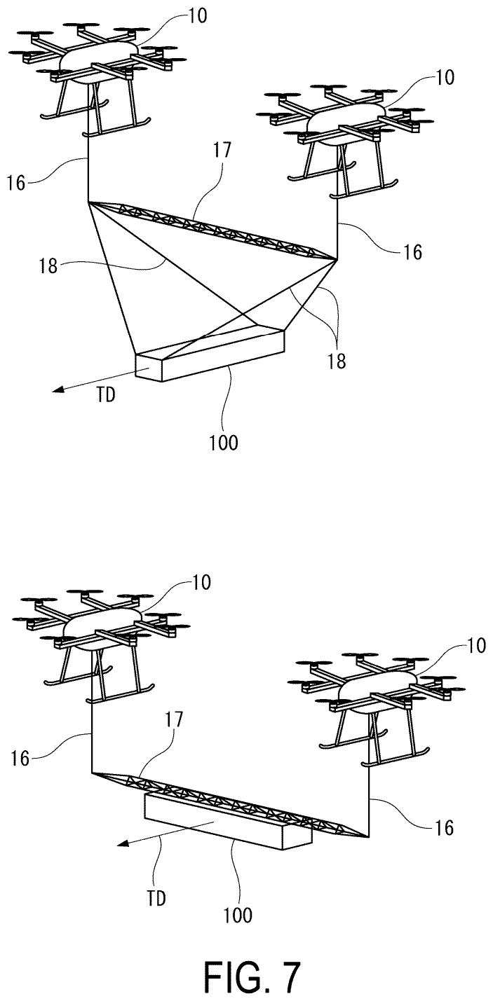

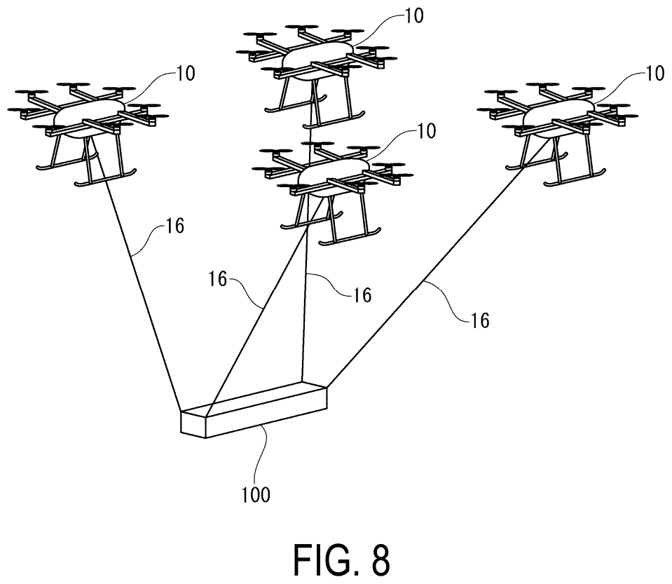

### Transport Formation: See FIGS. 7 and 8

Some examples of formations of transporting the cargo 100 by the multiple UAVs 10 are illustrated.

FIG. 7 illustrates two examples of transporting the cargo 100 by two UAVs 10. The two examples both use a shared suspension implement 17.

In one example, the shared suspension implement 17 is interposed between two suspension cables 16 and four restraining cables 18. In this example, the long cargo 100 is transported facing a transport direction TD.

In the other example, the cargo 100 is directly supported by the shared suspension implement 17, and the shared suspension implement 17 is suspended and supported by two UAVs 10 using two suspension cables 16. In this example, the long cargo 100 is transported facing a direction orthogonal to the transport direction TD.

FIG. 8 illustrates an example of transporting the cargo 100 by four UAVs 10.

In this example, the long cargo 100, which is transported facing the transport direction TD, is suspended from two UAVs 10 on a front (F) side, and suspended from two other UAVs 10 on a rear (R) side.

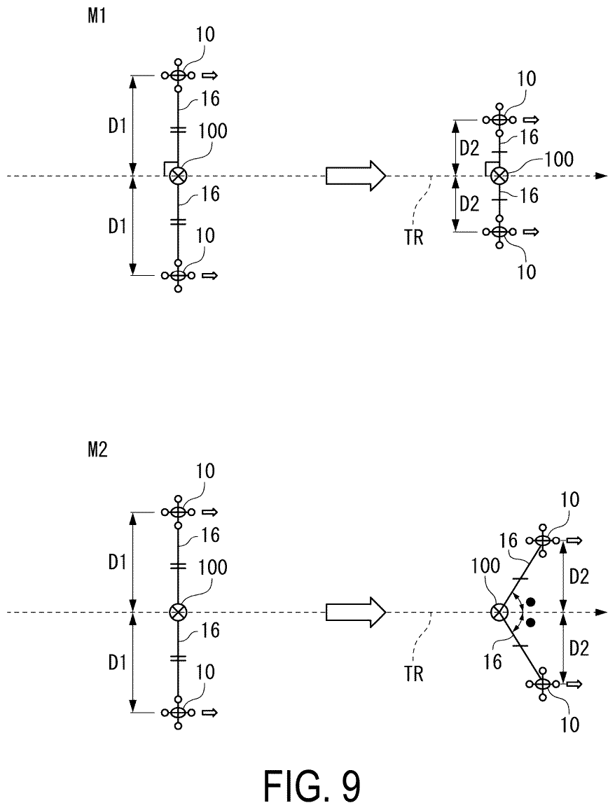

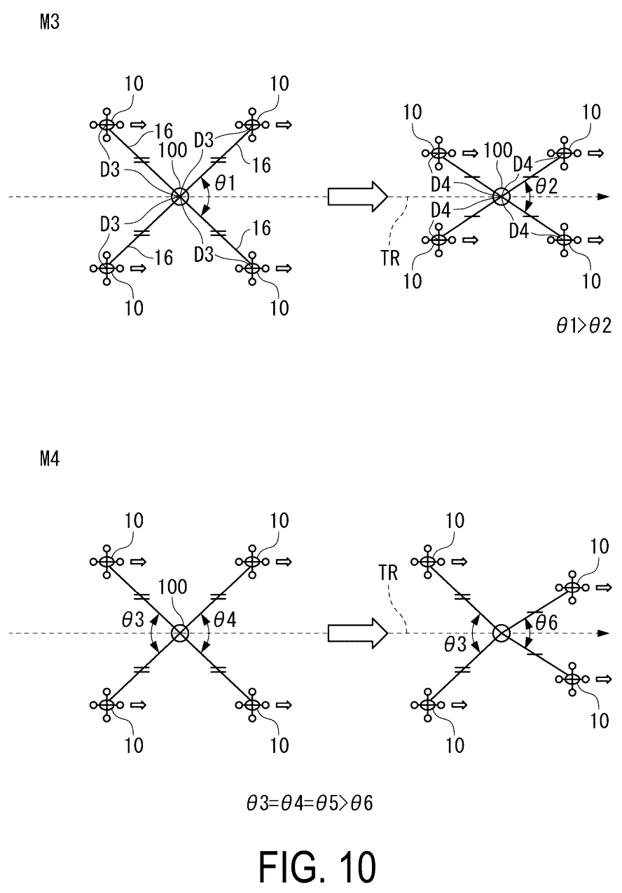

### Similar Types of Maintaining Relative Positional Relationship: See FIGS. 9 and 10

There are examples other than those described above in which the relative positional relationship of each of the multiple UAVs 10 to the cargo 100 is maintained.

First, a case in which the cargo 100 is transported by two UAVs 10 will be described with reference to FIG. 9. Note that FIGS. 9 and 10 are plan views of the UAVs 10 that transport the cargo 100.

The two UAVs 10 transport the cargo 100 while maintaining an equal interval D1 from the cargo 100. After that, even when the cargo 100 is transported while maintaining an equal interval D2 (D2+D1) from the cargo 100, the relative positional relationship of each of the multiple UAVs 10 to the cargo 100 is maintained (M1 in FIG. 9). As an example, the suspension cables 16 are orthogonal to the transport route TR. In this example in M1, the intervals from the cargo 100 to the two UAVs 10 in the vertical direction also change. The same applies to the following example.

In the next example illustrated in M2 in FIG. 9, the two UAVs 10 transport the cargo 100 while maintaining an equal interval D1 from the cargo 100, and then transport the cargo 100 while maintaining an equal interval D2 (D2≈D1) from the cargo 100, which is the same as the example in M1. However, the suspension cables 16 are initially orthogonal to the transport route TR, as an example, but the angles of the suspension cables 16 are changed thereafter. Even in this case, it is assumed that the relative positional relationship of each of the multiple UAVs 10 to the cargo 100 is maintained (M2 in FIG. 9).

FIGS. 10 (M3 and M4) illustrates examples in which the cargo 100 is transported by four UAVs 10.

The four UAVs 10 transport the cargo 100 while maintaining an equal interval D3 from the cargo 100, and then transport the cargo 100 while maintaining an equal interval D4 (D3≈D4) from the cargo 100. Even in this case, the relative positional relationship of each of the multiple UAVs 10 to the cargo 100 is maintained (M3 in FIG. 9). In this example in M3, an angle formed by the four suspension cables 16 to the transport route TR is also changed. However, as illustrated in the example in M4, an angle formed by the two suspension cables 16 to the transport route TR is changed, but an angle formed by the other two suspension cables 16 to the transport route TR may be maintained.

Considering also the examples in FIGS. 9 and 10, maintaining the relative positional relationship in the present disclosure is defined as follows. That is, even when a pair of two unmanned aerial vehicles 10 and 10, which are in a symmetrical relationship in the horizontal direction (xy direction) with reference to the transport route TR, change their respective intervals from the transport route TR, as long as the symmetrical relationship is maintained, this corresponds to maintaining the relative positional relationship in the present disclosure. When their respective intervals from the transport route TR are the same, the positional relationship is maintained constant.

Supplementary Notes: The present disclosure is grasped as follows.

### Supplementary Note 1

In a method of transporting cargo (100) suspended by multiple unmanned aerial vehicles (10), the multiple unmanned aerial vehicles (10) each fly while controlling positions of the multiple unmanned aerial vehicles (10) with reference to a position of the cargo (100).

### Supplementary Note 2

In Supplementary Note 1, preferably, each of the multiple unmanned aerial vehicles (10) flies while a relative positional relationship of each of the multiple unmanned aerial vehicles (10) to the cargo (100) is maintained.

### Supplementary Note 3

In Supplementary Note 2, preferably, maintaining the relative positional relationship of each of the multiple unmanned aerial vehicles (10) to the cargo (100) is achieved by one or both of a ground position control mode in which flight of each of the multiple unmanned aerial vehicles (10) is controlled while following a change in a position of the cargo (100) relative to the ground, and an interval control mode in which the flight of each of the multiple unmanned aerial vehicles (10) is controlled while maintaining an interval of each of the multiple unmanned aerial vehicles (10) to the cargo (100).

### Supplementary Note 4

The method of transporting cargo (100) in Supplementary Note 3, preferably includes, in the ground position control mode, acquiring current location information (LI) of the cargo (100) to be transported by each of the multiple unmanned aerial vehicles (10), and controlling the flight of each of the multiple unmanned aerial vehicles (10) while maintaining a relative positional relationship of each of the multiple unmanned aerial vehicles (10) to the current location information (LI).

### Supplementary Note 5

In Supplementary Note 4, preferably, in the acquiring current location information (LI), the current location information (LI) is ground location information acquired from a global navigation satellite system and is transmitted to each of the multiple unmanned aerial vehicles (10), and in the controlling the flight, each of the multiple unmanned aerial vehicles (10) flies based on the ground location information.

### Supplementary Note 6

The method of transporting cargo (100) in Supplementary Note 3, preferably includes, in the interval control mode, measuring an interval between each of the multiple unmanned aerial vehicles (10) and the cargo (100), and controlling the flight of each of the multiple unmanned aerial vehicles (10) while maintaining the interval between the multiple unmanned aerial vehicles (10).

### Supplementary Note 7

In Supplementary Note 6, preferably, the interval between each of the multiple unmanned aerial vehicles (10) and the cargo (100) is measured by one or both of a distance measuring sensor (19) provided in the cargo (100) and a distance measuring sensor (19) provided in each of the multiple unmanned aerial vehicles (10), or measured by comparing ground location information in the cargo (100) acquired from the global navigation satellite system (GNSS) with ground location information in each of the multiple unmanned aerial vehicles (10) acquired from the global navigation satellite system (GNSS).

Besides the above-described embodiment, configurations explained in the above-described embodiment can be selected or omitted as desired or can be changed to other configurations as necessary.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A method of transporting cargo suspended by multiple unmanned aerial vehicles, wherein
the multiple unmanned aerial vehicles each fly while controlling positions of the multiple unmanned aerial vehicles with reference to a position of the cargo.

2. The method of transporting cargo according to claim 1, wherein each of the multiple unmanned aerial vehicles flies while a relative positional relationship of each of the multiple unmanned aerial vehicles to the cargo is maintained.

3. The method of transporting cargo according to claim 2, wherein
maintaining the relative positional relationship of each of the multiple unmanned aerial vehicles to the cargo is achieved by one or both of
a ground position control mode in which flight of each of the multiple unmanned aerial vehicles is controlled while following a change in a position of the cargo relative to the ground, and
an interval control mode in which the flight of each of the multiple unmanned aerial vehicles is controlled while maintaining an interval of each of the multiple unmanned aerial vehicles to the cargo.

4. The method of transporting cargo according to claim 3, comprising, in the ground position control mode:
acquiring current location information of the cargo to be transported by each of the multiple unmanned aerial vehicles; and
controlling the flight of each of the multiple unmanned aerial vehicles while maintaining a relative positional relationship of each of the multiple unmanned aerial vehicles to the current location information.

5. The method of transporting cargo according to claim 4, wherein
in the acquiring current location information, the current location information is ground location information acquired from a global navigation satellite system and is transmitted to each of the multiple unmanned aerial vehicles, and
in the controlling the flight, each of the multiple unmanned aerial vehicles flies based on the ground location information.

6. The method of transporting cargo according to claim 3, comprising, in the interval control mode:
measuring an interval between each of the multiple unmanned aerial vehicles and the cargo; and
controlling the flight of each of the multiple unmanned aerial vehicles while maintaining the interval between the multiple unmanned aerial vehicles.

7. The method of transporting cargo according to claim 6, wherein
the interval between each of the multiple unmanned aerial vehicles and the cargo is
measured by one or both of a distance measuring sensor provided in the cargo and a distance measuring sensor provided in each of the multiple unmanned aerial vehicles, or
measured by comparing ground location information in the cargo acquired from the global navigation satellite system with ground location information in each of the multiple unmanned aerial vehicles acquired from the global navigation satellite system.
